(19) United States
(12) Patent Application Publication
(10) Pub. No.: US 2025/0187385 A1
(43) Pub. Date: Jun. 12, 2025

(54) TRAILER SUSPENSION ASSEMBLY AND METHOD OF USE

(71) Applicant: M&R Specialty Trailers and Trucks Inc., Macclenny, FL (US)

(72) Inventors: Richard Willis, Macclenny, FL (US); Joseph L. Gardner, Macclenny, FL (US)

(73) Assignee: M&R Specialty Trailers and Trucks Inc., Macclenny, FL (US)

(21) Appl. No.: 18/972,806

(22) Filed: Dec. 6, 2024

Related U.S. Application Data
(60) Provisional application No. 63/606,975, filed on Dec. 6, 2023.

(51) Int. Cl. B60G 17/005

(52) U.S. Cl. CPC B60G 17/005; B60G 2204/4604

(57) ABSTRACT

A trailer suspension assembly for an associated trailer frame includes a mounting bracket; a leg connected to the mounting bracket; a locking system configured to be selectively locked or unlocked; wherein, when locked, the locking system is configured to prevent rotation of the leg to prevent movement of the associated trailer frame.

### A. FIELD OF THE DISCLOSURE

This disclosure relates to an independent suspension assembly and method of use with an adjustable height trailer which includes a suspension subassembly configured to be rotatably coupled to the trailer frame.

### B. BACKGROUND

Trailers are commonly outfitted with independent suspension systems which do not require a traditional axle coupled to the wheels. Such “axle-less” suspension assemblies are affixed to the structural frame of the trailer. Conventional axle-less suspension assemblies are positioned substantially fixed relative to the frame of the trailer and are not configured for rotation relative to the frame.

In certain trailer applications, such as exhibits, once a trailer has been transported to the site of usage, it is desirable to lower the trailer to a base position such that the trailer's bottom frame is substantially resting on the surface of the ground or pavement. Being able to reposition the trailer's bottom frame to the ground provides more convenient access for the user and for the consumer to be able to walk inside of the trailer or to access a service window counter. However, the frame mounting positions of the conventional axle-less suspension assemblies are not configured to allow the trailer to be lowered to such a full extent.

### BRIEF SUMMARY OF THE DISCLOSURE

A trailer suspension assembly for adjustable height trailers as disclosed herein is configured to allow automated reversable positioning of a trailer from a transport position to a base position. A plurality of trailer suspension assemblies is connected to an adjustable height trailer. The adjustable height trailer includes a trailer frame, a plurality of wheel wells, at least one pair of wheels, a height adjustment system, and a set of two or more telescoping pedestals. The trailer frame includes a pair of longitudinal interior framing members, a pair of longitudinal exterior framing members, at least one pair of interior bearing systems, and at least one pair of exterior bearing systems.

The height adjustment system is configured to control the extension and retraction of the telescoping pedestals to allow adjustment of the height of the trailer frame from an elevated transport position to a base position on the ground, and back again.

Each of the trailer suspension assemblies includes a suspension subassembly, a transfer shaft, a leg, and a locking system. The suspension subassembly is configured to be rotatably coupled to the trailer frame via the transfer shaft. Each transfer shaft spans between one of the longitudinal interior framing members and one of the longitudinal exterior framing members and is pivotably attached thereto via a respective interior bearing system and a respective exterior bearing system. The transfer shaft is rigidly connected to one end of the suspension subassembly and a wheel is connected to the other end. The leg is rigidly connected to the top of the suspension subassembly.

The suspension subassembly includes a mounting bracket, a first rubber spring, a second rubber spring, a pivot arm, and a spindle. The suspension subassembly acts as an intermediate connection between the wheel and the transfer shaft and is configured to transfer forces between the wheel and the transfer shaft to the trailer frame when the leg is secured in a stationary position by the locking mechanism. In the stationary position, the trailer weight may be transferred from the wheels to the suspension subassemblies, from the suspension subassemblies to the transfer shafts, from the transfer shafts to the trailer frame, then from the trailer frame to the telescoping pedestals setting on the ground.

The locking system is configured to selectively prevent rotation of the leg, the mounting bracket, and the transfer shaft. The locking system includes a securing assembly, a tab, a latch, a locking pin, and a latch support assembly. The securing assembly preferably includes a guide arm coupled to a pivot shaft and a counterweight attached to the pivot shaft, a vertical interior support member, a vertical exterior support member, and a cross brace. The pivot shaft spans between the vertical interior support member and the vertical exterior support member and is pivotably attached thereto. The opposing vertical support members connect to the trailer frame longitudinal framing members. The tab is attached to the side of the distal end of the pivot shaft. The latch is located adjacent to the tab and configured for removable securement of the tab to prevent rotation of the pivot shaft. The fixed end of the guide arm is attached to the side of the pivot shaft and the free end of the guide arm is configured for removable contact with the top surface of the leg. When the leg is in the transport position, it is substantially horizontal and the guide arm is positioned substantially perpendicular to it, whereby the bottom of the free end of the guide arm is in contact with the top of the leg.

When the locking pin is removed and the latch is unlatching from the tab, the guide arm will be free to rotate, disengaging from the leg, allowing the leg and suspension subassembly to rotate and pivot about the longitudinal axis of the transfer shaft. As the trailer frame is lowered toward the ground via retracting the pedestals, then the transfer shaft, the mounting bracket, and the leg rotate back towards the front end of the trailer. To reverse, the trailer frame is raised up from the ground via extension of the pedestals, causing the transfer shaft, the mounting bracket, and the leg to rotate back towards the rear end of the trailer.

### BRIEF DESCRIPTION OF THE DRAWINGS

FIG. 1 is a left side view of an exemplary non-limiting pair of trailer suspension assemblies within an adjustable height trailer shown parked and configured to be lowered towards the ground.

FIG. 2 is a schematic top section view of the trailer suspension assemblies of FIG. 1.

FIG. 3 is a left side sectional view of the trailer suspension assemblies of FIG. 2 wherein the trailer frame is shown in the transport position and a set of telescoping pedestals are shown in a substantially retracted position.

FIG. 4 shows the trailer suspension assemblies of FIG. 3 wherein the height adjustment system is extending a set of telescoping pedestals downwards towards the ground.

FIG. 5 shows the trailer suspension assemblies of FIG. 4 in a stationary position wherein the height adjustment system has extended the set of telescoping pedestals to be in contact with the ground and such that the frame is elevated slightly whereby the wheels of the trailer are elevated above the ground by a predetermined distance.

FIG. 6 shows the trailer suspension assemblies of FIG. 5 wherein the height adjustment system has retracted the set of telescoping pedestals to an intermediate position, allowing the frame to be lowered towards the ground, which pivotably rotates the transfer shaft and mounting bracket back toward the front end of the trailer.

FIG. 7 shows the trailer suspension assemblies of FIG. 6 wherein the height adjustment system has fully retracted the set of telescoping pedestals to the base position, allowing the bottom of the frame to be set on the ground, which completes the pivotable rotation of the transfer shaft and mounting bracket back toward the front end of the trailer.

FIG. 8 is a left side front exterior perspective view of a wheel well with the pair of trailer suspension assemblies of FIG. 3.

FIG. 9 is a left side rear exterior perspective view of the wheel well with the pair of trailer suspension assemblies of FIG. 8.

FIG. 10 is a left side front interior perspective view of the wheel well with the pair of trailer suspension assemblies of FIG. 7 with the trailer frame in the base position.

### NUMBERING REFERENCE

1—Trailer Suspension assembly
4—Adjustable height trailer
7—Vehicle
10—Trailer frame
12—Wheel Well
14—Wheel
16—Height adjustment system
18—Pedestals
20—Longitudinal interior framing members
22—Longitudinal exterior framing members
24—Interior bearing system
26—Exterior bearing system
28—Foot
30—Suspension subassembly
32—Transfer shaft
34—Leg
40—Locking system
42—Mounting bracket
44—Aperture
46—Passage
48—Pivot arm
50—Spindle
52—Securing assembly
54—Tab
56—Latch
58—Locking Pin
60—Guide arm
62—Counterweight
64—Pivot shaft
66—Vertical interior support member
68—Vertical exterior support member
69—Cross brace
70—Latch support assembly
72—Stub column
74—Latch bracket
X—Predetermined height

### DETAILED DESCRIPTION OF THE EMBODIMENTS

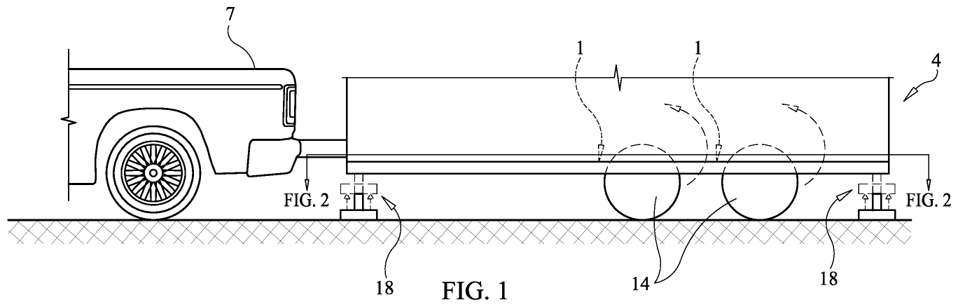

As shown in FIGS. 1-3, a plurality of exemplary non-limiting trailer suspension assemblies 1 (two of which are shown in FIG. 1, although any suitable number of trailer suspension assemblies 1 can be included) are connected to an adjustable height trailer 4, where the trailer may be transported to a site by a vehicle 7. Once unhitched from the vehicle 7, the adjustable height trailer may be lowered from a transport position, where the trailer weight is supported by the wheels 4, to a base position on the ground of the Earth.

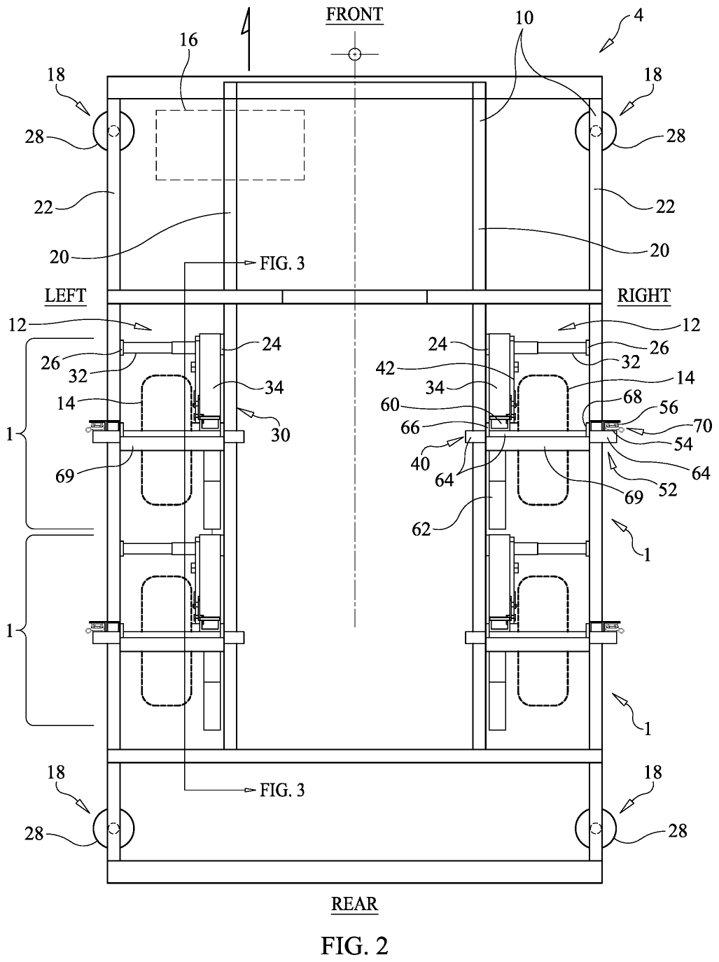

As shown in FIG. 2, the adjustable height trailer 4 (hereinafter referred to as trailer 4) includes a trailer frame 10, a plurality of wheel wells 12, at least one pair of wheels 14, a height adjustment system 16 (shown schematically in FIG. 2 by dashed lines) and a set of two or more telescoping pedestals 18. The trailer frame 10 includes a pair of longitudinal interior framing members 20, a pair of longitudinal exterior framing members 22, at least one pair of interior bearing systems 24, and at least one pair of exterior bearing systems 26.

Each wheel well 12 is disposed between one of the longitudinal interior framing members 20 and one of the longitudinal exterior framing members 22. Each pair of interior bearing systems 24 is rigidly attached to a respective longitudinal interior framing member 20. Each pair of exterior bearing systems 26 is rigidly attached to a respective longitudinal exterior framing member 22.

The height adjustment system 16 may be any suitable system configured to automatically actuate and control the extension and retraction of the telescoping pedestals 18 (herein after as pedestal(s) 18), such as a remote controlled hydraulic or electro-mechanical system. In one embodiment, the height adjustment system 16 is configured for communication with and actuation of four pedestals 18. Each pedestal 18 is disposed on the trailer 4 (for a total of four pedestals 18, one pedestal 18 in each of the four corners of the trailer 4) and includes a foot 28 at the bottom configured for leveling/stabilizing placement on the ground surface. Only the bottom portion of the pedestals 18 are shown in the FIG. 2. Each of the pedestals 18 are configured for extension of the foot 28 downward to set on the ground, where the four pedestals provide bearing support of substantially the full weight of the trailer 4. Once trailer 4 is in the unlocked position, the pedestals 18 are actuated to retract, allowing the bottom of the trailer to be lowered to the ground to the base position. Later, once the trailer 4 is ready for conversion, the pedestals 18 are actuated to extend towards the ground, allowing the bottom of the trailer to be raised up from the ground back to the intermediate position, back to the stationary position.

As shown in FIG. 2, each of the trailer suspension assemblies 1 includes a suspension subassembly 30, a transfer shaft 32, a leg 34, and a locking system 40. The suspension subassembly 30 is configured to be rotatably coupled to the trailer frame 10 via the transfer shaft 32. The transfer shaft 32 spans a length between one of the longitudinal interior framing members 20 and one of the longitudinal exterior framing members 22, and is pivotably attached thereto via a respective interior bearing system 24 and a respective exterior bearing system 26.

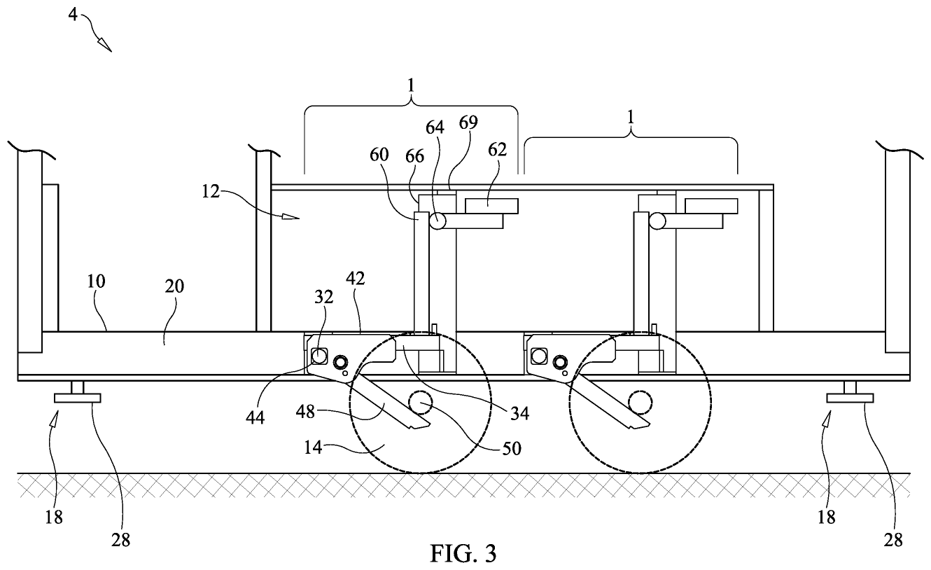

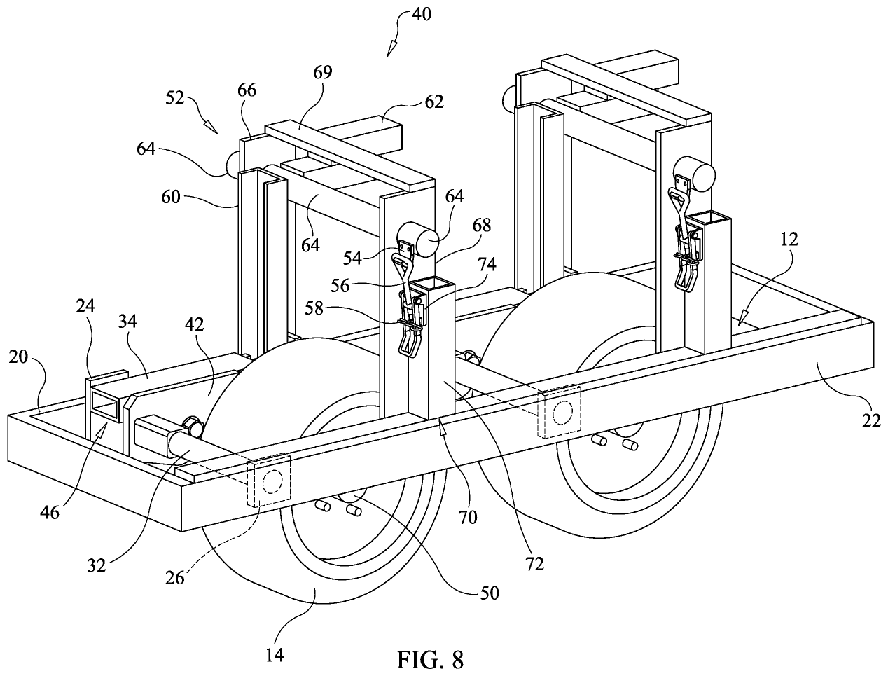

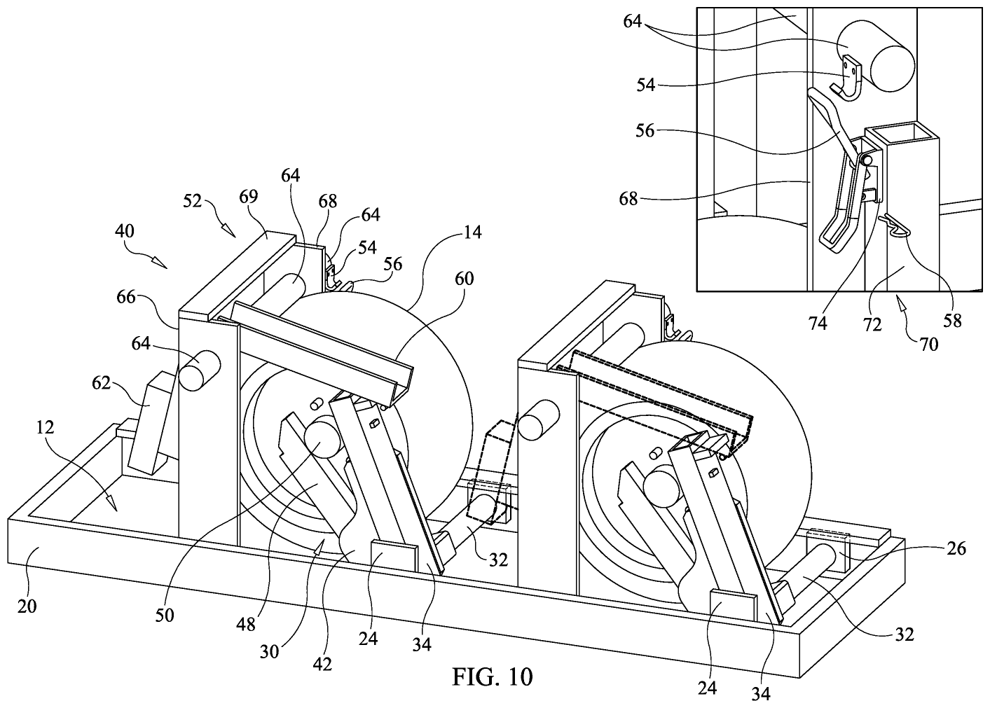

With reference to FIGS. 3-10, the suspension subassembly 30 includes a mounting bracket 42, a first rubber spring (hidden/not shown), a second rubber spring (hidden/not shown), a pivot arm 48, and a spindle 50. The rubber springs allow for a slight amount of deflection (approximately 1 to 3.5 inches) of a center of the spindle 50, and thus the wheel 14 as well, to provide shock absorption. The suspension subassembly 30 acts as an intermediate connection between the wheel 14 and the transfer shaft 32, and is configured to transfer forces between the wheel 14 and the transfer shaft 32 to the frame 10 when the leg 34 is secured in a stationary position by the locking system 40. Each side of the mounting bracket 42 of the suspension subassembly 30 includes opposing apertures 44 (one aperture 44 being shown in FIG. 3) at one end and a passage 46 (as best shown in FIG. 8) therebetween and is configured to allow a structural member (not shown) to be inserted therein, or alternatively allow two opposing structural members to be rigidly connected, one at each aperture 44. The transfer shaft 32 is rigidly (e.g., welded, with adhesives, or with any other suitable attaching mechanism) connected to mounting bracket 42 (approximately perpendicularly) at each aperture 44. A proximal end of the pivot arm 48 is rotatably coupled to the mounting bracket 42 at approximately the center of the mounting bracket. The distal end of the pivot arm 48 is connected to the spindle 50. The spindle 50 is rotatably connected to the wheel 14. The leg 34 may be formed of any suitable structural members, such as a rectangular hollow structural steel tube. A bottom side of the leg 34 is rigidly connected to the top of the mounting bracket 42 and is disposed in a substantially horizontal position when the leg is secured in a stationary position by the locking system 40.

In the stationary position, a bearing of the trailer weight may be transferred from the wheels 14 to the suspension subassemblies 30, then from the suspension subassemblies 30 to the transfer shafts 32, then from the transfer shafts 32 to the trailer frame 10, then from the trailer frame 10 to the telescoping pedestals 18 setting on the ground.

The locking system 40 is configured to be selectively locked or unlocked, and when locked, is configured to prevent rotation of the leg 34, the mounting bracket 42, and the transfer shaft 32 (from rotating back toward the front of the trailer frame 10 when the trailer frame 10 is in the transport position). In an exemplary embodiment as shown in FIG. 8, the locking system 40 includes a securing assembly 52, a tab 54, a latch 56, a locking pin 58, and a latch support assembly 70. The securing assembly 52 includes a guide arm 60 and counterweight 62 attached to a pivot shaft 64, a vertical interior support member 66, a vertical exterior support member 68, and a cross brace 69. The pivot shaft 64 spans a length between the vertical interior support member 66 and the vertical exterior support member 68 and is pivotably attached thereto via openings (shown as blocked in the FIGS by the pivot shaft 64) in the vertical interior support member 66 and the vertical exterior support member 68. An exterior end of the pivot shaft 64 extends a pre-determined distance away from the vertical interior support member 66, and tab 54 is rigidly attached to the exterior end of the pivot shaft 64, adjacent to a distal end of the pivot shaft 64. A proximal end of the vertical interior support member 66 is coupled to the longitudinal interior framing member 20, and a proximal end of the vertical exterior support member 68 is coupled to the longitudinal exterior framing member 22. A distal end of the vertical interior support member 66 is coupled to an interior end of cross brace 69 and a distal end of the vertical exterior support member 68 is coupled to an exterior end of the cross brace 69.

The guide arm 60 is coupled to the pivot shaft 64, and the counterweight 62 is configured to bias the guide arm 60 such that when the frame 10 is being lowered and the guide arm 60 is freed to rotate relative to the frame 10, the guide arm 60 is urged to rotate back toward a rear of the trailer 4. As such, a distal end of the guide arm 60 is rotating up so as not to interfere with, or otherwise contact or inhibit, the distal end of the leg 34 which is simultaneously rotating back toward the front of the trailer 4.

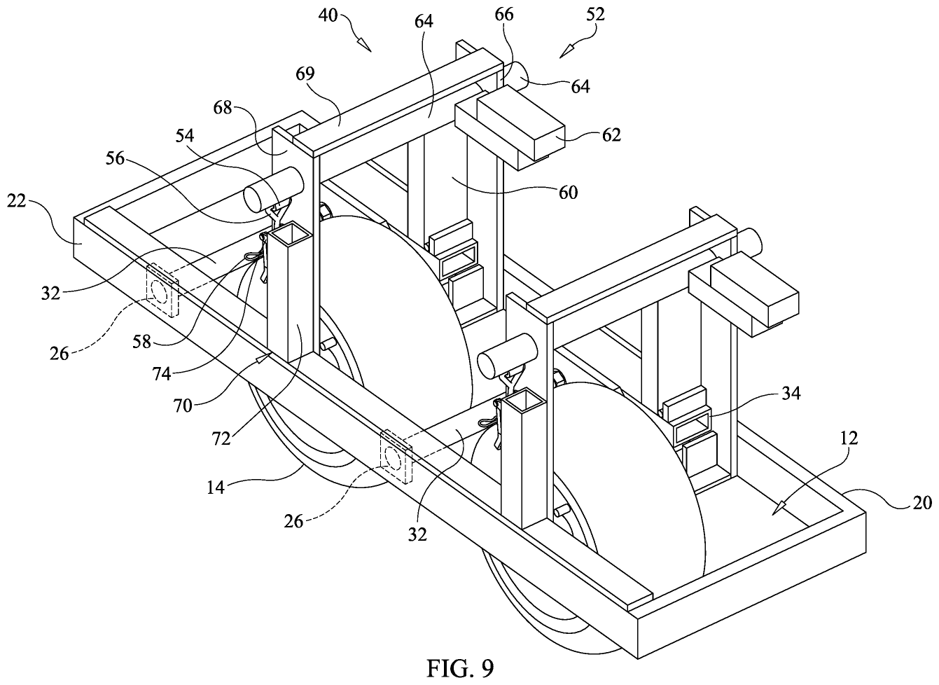

With continuing reference to FIGS. 8 and 9, the latch support assembly 70 includes a stub column 72 and a latch bracket 74. The stub column 72 is disposed adjacent to, and parallel with, the vertical exterior support member 68 and is coupled to an exterior of the longitudinal framing member 22. The latch bracket 74 is attached to a front side and a distal top end of the stub column 72. The latch 56 is pivotably attached to the latch bracket 74 and positioned on the latch bracket 74 to align adjacent to the tab 54. The latch 56 is configured for removable securement with the tab 54 to prevent rotation of the pivot shaft 64 within the vertical exterior support member 64. The locking pin 58 is configured for attachment to the latch bracket 74 to secure the latch 56 in place (i.e., the locking pin 58 prevents the latch 56 from rotating) when the trailer 4 is raised so the wheels 14 will be engaged for travel.

A first end of the guide arm 60 fixed to the longitudinal interior framing member 20 is attached to a side of the pivot shaft 64, and an opposing second “free” end of the guide arm 60 is configured for removable contact with a top surface of the leg 34. When the leg 34 is in a transport position, it is substantially horizontal relative to the frame 10 and the guide arm 60 is positioned substantially perpendicular to the leg 34, whereby the bottom of the free end of the guide arm 60 is in contact with the 23 top of the leg 34, as shown in FIG. 8.

The locking pin 58 may be any suitable removable pin or locking device (such as a cotter pin or a security lock) which is utilized to secure the latch 56 in a locked position, i.e., secured to the tab 54. Once the locking pin 58 is removed and the latch 56 is unlatched from the tab 54, the guide arm 60 is free to rotate about the pivot shaft 64, thereby disengaging from the leg 34. This disengagement allows the leg 34 and suspension subassembly 30 to rotate and pivot about the longitudinal axis of the transfer shaft 32.

The guide arm 60 may be made from a c-channel or rectangular hollow structural steel tube. However, the guide arm 60 may include a variety of alternative cross-sectional profiles. Such alternative cross-sectional profiles may include, but are not limited to, a c-channel, a wide flange, a tee or double tee, an angle, or any other hot rolled, cold-formed, or built-up cross-section.

### METHOD OF OPERATION

In general operation of the trailer suspension assemblies 1, a user temporarily shifts a weight of the trailer 4 from the wheels to the pedestals 18 by extending the pedestals 18 to engage with the ground of the Earth. Once the weight of the trailer 4 has been shifted to the pedestals 18, the user may “unlock” the locking system 40 to allow the pivot shaft 64 to rotate, which allows the transfer shaft 32 to rotate downward relative to the longitudinal interior framing member 20, and the user may then lower the bottom of the trailer 4 to the ground to the base position by retracting the pedestals 18.

In the transport position, as best seen in FIGS. 3, 8 and 9, the bottom of trailer frame 10 is at a predetermined height, and the locking system 40 is configured as “locked” to prevent the rotation of the pivot shaft 64 within the vertical interior support member 66 and the vertical exterior support member 68, which prevents the rotation of transfer shaft 32 back toward the front of the trailer frame 10.

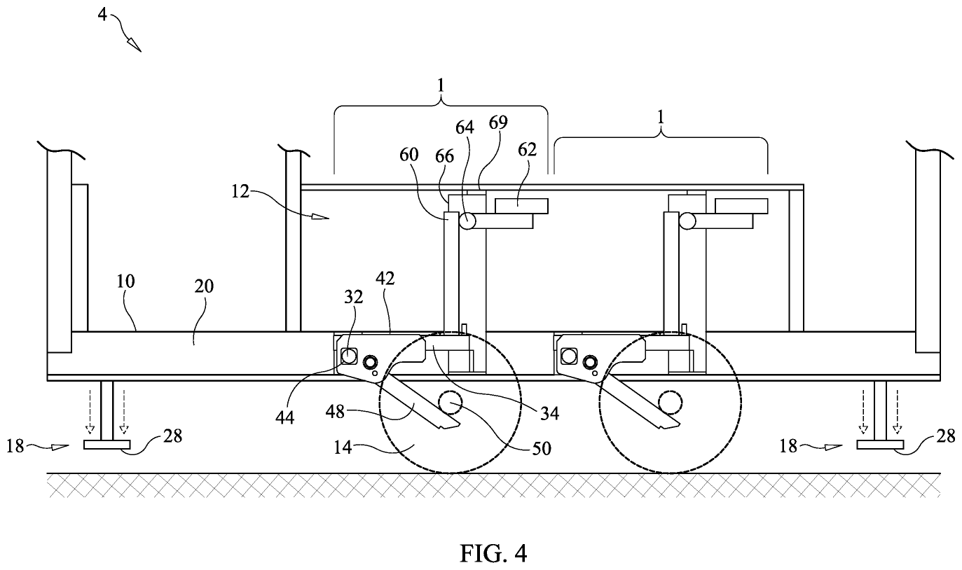

In a first step, as shown in FIG. 4, the user controls the height adjustment system 16 to actuate extension of the pedestals 18 (see FIG. 4) with feet 28 (four of which are shown in FIG. 4) toward the ground, until all the feet 28 are set on the ground.

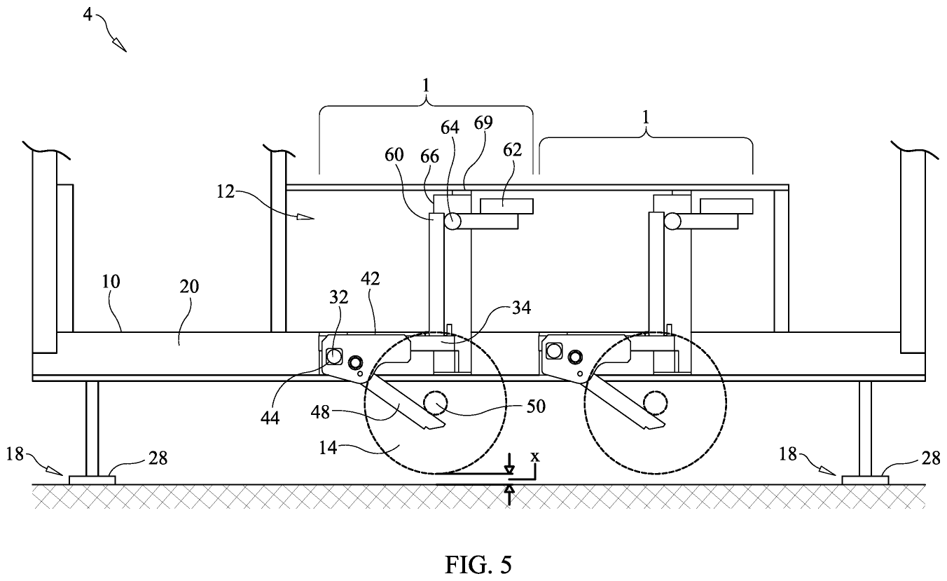

As shown in FIG. 5, with the wheels 14 initially still on the ground, once the feet 28 are all set/leveled/stabilized against the ground, the user may slightly extend the pedestals 18 further towards the ground to raise the frame 10 slightly from its transport position, and to raise the bottom of the wheels 14 above the ground at a predetermined height X. The predetermined height X may be approximately about 1 to 2 inches, providing enough height to allow the wheels 14 to be capable of free-spinning. (Recall that the rubber springs of the suspension subassembly 30 allow for a slight amount (i.e., approximately 1 to 3.5 inches) of deflection). At this point, the weight of the trailer 4 is transferred to the pedestals 18 (see FIG. 5), and the bottom of the trailer frame 10 is in the stationary position. Raising the trailer 4 slightly above the ground also allows a slight rotation of the transfer shaft 32 toward the rear of the trailer 4 (in a clockwise direction, if looking at the mounting bracket 42 from the left exterior of the trailer 4, and in a counterclockwise direction, if looking from the right exterior of the trailer 4), and likewise, allows a slight rotation of the suspension subassembly 30 with the leg 34. As a distal end of leg 34 moves slightly downward, the movement of the leg 34 allows disengagement of the guide arm 60 from the leg 34, whereby the bottom of the guide arm 60 moves slightly apart from the leg 34 at a distance to provide the guide arm 60 clearance to rotate relative to the longitudinal interior framing member 20 (this amount of slight rotation of the suspension subassembly 30 is not shown in the FIG. 5 as compared to FIG. 4).

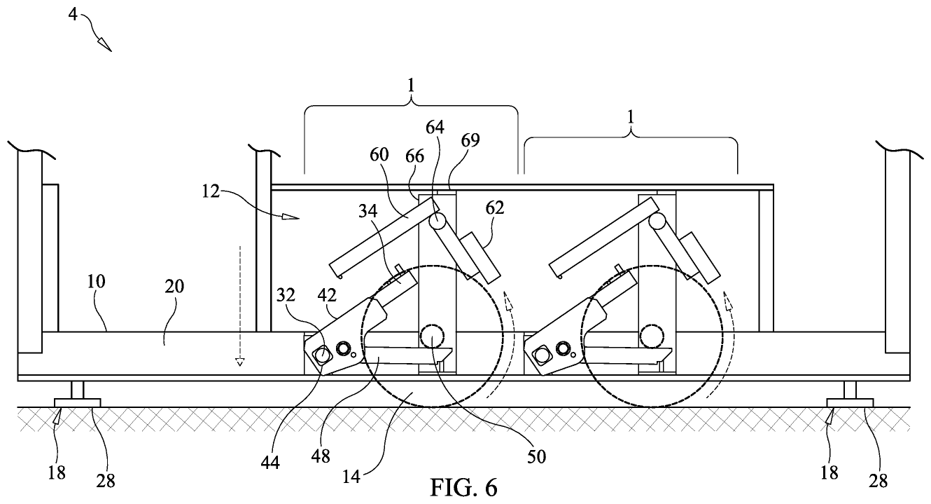

In the next step, as shown in FIG. 6, the user removes the locking pin 58, which unlatches the latch 56 from the tab 54, allowing the pivot shaft 64 to rotate, which allows the guide arm 60 to rotate relative to the longitudinal interior framing member 20 once the transfer shaft 32 is rotated relative to the longitudinal interior framing member 20. Next, the user controls the height adjustment system 16 to actuate slow retraction of the pedestals 18 (see FIG. 6) with the feet 28 still on the ground, thus lowering of the bottom of frame 10 toward the ground. As the frame 10 is lowered, the transfer shaft 32 also moves vertically downward with the frame 10, and the pivot arm 48 and spindle 50 both rotate relative to the wheel 14. As such, the transfer shaft 32 and the mounting bracket 42 rotate towards the front of the trailer 4 (in a counterclockwise direction, looking at the mounting bracket 42 from the left exterior of the trailer 4, and in a clockwise direction, if looking from the right exterior of the trailer 4) about a longitudinal horizontal axis of the transfer shaft 32. It follows that the attached leg 34 then rotates counterclockwise. As the leg 34 rotates counterclockwise, a distal end thereof also urges the distal end of the guide arm 60 to rotate clockwise to a point where the counterweight 62 begins to urge rotation of the guide arm 60 clockwise about the pivot shaft 64, causing the distal end of the guide arm 60 to initially move adjacent to a top surface of the leg 34. The guide arm 60 is further urged by the counterweight 62 until the guide arm 60 is suspended above the leg 34 in an intermediate position (see FIG. 6). Here, the leg 34 has rotated about 33 to 37 degrees from its transport position.

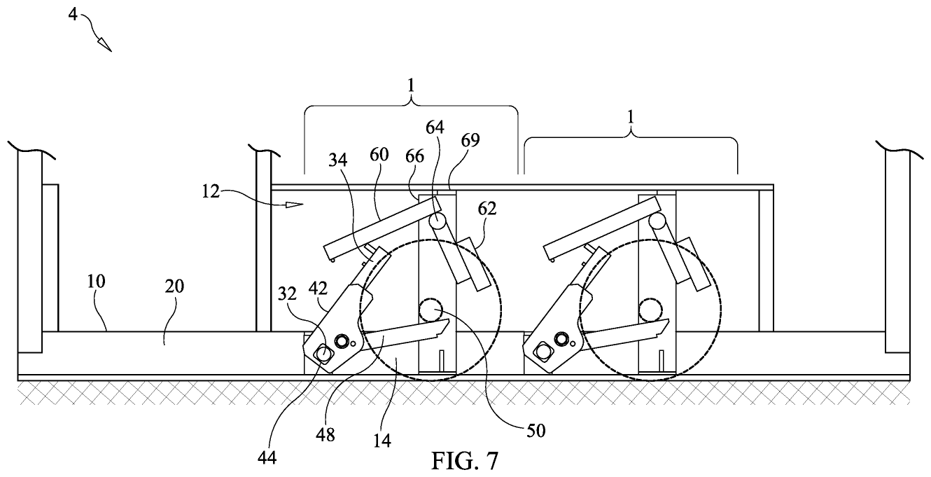

As shown in FIG. 7, continued slow retraction of the pedestals allows the frame 10 to continue to be lowered towards the ground, and the transfer shaft 32 and the mounting bracket 42 continue rotating counterclockwise such that the distal end of leg 34 slides near a bottom of the guide arm 60, and until the bottom of the frame 10 sets on the ground at the base position, as shown in FIG. 7. Once at the base position, the leg 34 has rotated about 50 to 54 degrees from its transport position.

To reverse the process, user controls the height adjustment system 16 to actuate extension of the pedestals 18 towards the ground to raise the frame 10, and as such, the transfer shaft 32 and the mounting bracket 42 rotate back towards a rear of the trailer 4, rotating clockwise (as viewed from the left exterior of the trailer 4). It follows that the attached leg 34 likewise rotates clockwise. The clockwise rotation of leg 34 allows guide arm 60 to rotate counterclockwise about the pivot shaft 64, until the guide arm 60 and counterweight 62 are free-hanging and balanced. As the leg 34 continues clockwise rotation, the guide arm 60 continues to rotate counterclockwise until the guide arm 60 becomes nearly vertically oriented, and the frame 10 moves back to the stationary position shown in FIG. 5. Once the bottom of frame is raised back up to the stationary position, the guide arm 60 is in position to secure the leg 34 and mounting bracket 42 in place to prevent further movement of the frame 10.

Next, with continuing reference to FIG. 5, the user controls the height adjustment system 16 to temporarily cease extension of the pedestals 18 (at a predetermined stop position). When the bottom of frame 10 is in the stationary position, the wheels 14 are still free to turn, but the bottom of the wheels 14 are close to the ground at the predetermined height x. Then, the user relocks the frame 10 and secures the pivot shafts 64 from rotation by locking latch 56 in a locked position to the tab 54, and inserts the locking pin 58 to secure the latch 56 from moving.

Next, the user controls the height adjustment system 16 to slightly retract the pedestals 18 (i.e., the feet 28 still stay on the ground), which lowers the bottom of the frame 10 slightly, and as such, the transfer shaft 32 and the mounting bracket 42 slightly rotate back towards the front of the trailer 4, rotating counterclockwise (Recall that the rubber springs of the suspension subassembly 30 allow for a slight amount (approximately 1 to 3.5 inches) of deflection). It follows that the attached leg 34 rotates slightly counterclockwise (as viewed from the left exterior side of the frame 4) to secure the leg 34 firmly against the guide arm 60, with a bottom distal end of the guide arm 60 contacting a top surface of the distal end of the leg 34; and the wheels 14 are set back on the ground. Next, the user controls the height adjustment system 16 to fully retract the pedestals 18 back up to their initial transport position. The bearing of the trailer weight is transferred sequentially back from the telescoping pedestals 18 to the trailer frame 10, from the trailer frame to the transfer shafts 32, from the transfer shafts to the suspension subassemblies 30 and then to the wheels 14. As such, the weight load of the trailer is transferred back to the wheels 14, and the bottom of trailer frame 10 is back in the transport position, at a predetermined height. As the latch 56 is secured with the tab 54, the pivot shaft 64 is locked from rotation and likewise, the mounting bracket 42 of suspension subassembly 30 is locked in place against rotation back toward the front of the trailer 4. With the trailer frame 10 being fully raised, the suspension subassembly 30 locked, and the wheels 14 engaged for travel, the trailer 4 may then be hitched back to vehicle 7 for transport.

The drawings also indicate various stops provided at various locations to assist with guidance and positioning of the various system members.

While the embodiments of the disclosure have been disclosed, certain modifications may be made by those skilled in the art to modify the disclosure without departing from the spirit of the disclosure.

1. A trailer suspension assembly for an associated trailer frame, the trailer suspension assembly comprising:
a mounting bracket;
a leg connected to the mounting bracket;
a locking system configured to be selectively locked or unlocked;
wherein, when locked, the locking system is configured to prevent rotation of the leg to prevent movement of the associated trailer frame.

2. The trailer suspension assembly of claim 1, further comprising:
a transfer shaft connected to the mounting bracket and configured to be rotatably coupled to the associated trailer frame;
wherein, when locked, the locking system is configured to prevent rotation of the transfer shaft to prevent movement of the associated trailer frame.

3. The trailer suspension assembly of claim 2, further comprising a suspension subassembly including:
the mounting bracket; and
a pivot arm rotatably connected to the mounting bracket;
wherein, when locked, the locking system is configured to prevent rotation of the mounting bracket to prevent movement of the associated trailer frame.

4. The trailer suspension assembly of claim 3, wherein the suspension subassembly further includes:
a spindle coupled to a portion of the pivot arm and coupled to an associated wheel connected to the associated trailer frame.

5. The trailer suspension assembly of claim 1, wherein the locking system further includes:
a securing assembly;
a tab connected to a portion of the securing assembly;
a latch support assembly;
a latch pivotably attached to a portion of the latch support assembly and aligned adjacent with the tab; and
a locking pin attached to a portion of the latch support assembly and configured to secure the latch to prevent movement of the latch.

6. The trailer suspension assembly of claim 5, wherein the securing assembly includes:
a vertical interior support member attached to a portion of the associated trailer frame;
a vertical exterior support member attached to a portion of the associated trailer frame and spaced from the vertical interior support member;
a pivot shaft connected to, and extending between, the vertical exterior support member and the vertical interior support member;
wherein the tab is attached to an end of the pivot shaft.

7. The trailer suspension assembly of claim 6, wherein the securing assembly further includes:
a guide arm coupled to the pivot shaft; and
a counterweight configured to bias the guide arm relative to the associated trailer frame.

8. The trailer suspension assembly of claim 5, wherein the latch support assembly includes:
a stub column disposed adjacent to the vertical exterior support member and coupled to a portion of the associated trailer frame; and
a latch bracket attached to a portion of the stub column;
wherein the latch is configured for removable securement with the tab to prevent rotation of the pivot shaft within the vertical exterior support member.

9. A trailer suspension assembly for an associated trailer frame, the trailer suspension assembly comprising:
a mounting bracket;
a transfer shaft connected to the mounting bracket and configured to be rotatably coupled to the associated trailer frame;
a locking system configured to be selectively locked or unlocked;
wherein, when locked, the locking system is configured to prevent rotation of the transfer shaft to prevent movement of the associated trailer frame.

10. The trailer suspension assembly of claim 9, further comprising:
a leg connected to the mounting bracket;
wherein, when locked, the locking system is configured to prevent rotation of the leg to prevent movement of an associated trailer frame.

11. The trailer suspension assembly of claim 10, further comprising a suspension subassembly including:
the mounting bracket; and
a pivot arm rotatably connected to the mounting bracket;
wherein, when locked, the locking system is configured to prevent rotation of the mounting bracket to prevent movement of the associated trailer frame.

12. The trailer suspension assembly of claim 3, wherein the suspension subassembly further includes:
a spindle coupled to a portion of the pivot arm and coupled to an associated wheel connected to the associated trailer frame.

9. he trailer suspension assembly of claim 9, wherein the locking system further includes:
a securing assembly;
a tab connected to a portion of the securing assembly;
a latch support assembly;
a latch pivotably attached to a portion of the latch support assembly and aligned adjacent with the tab; and
a locking pin attached to a portion of the latch support assembly and configured to secure the latch to prevent movement of the latch.

14. The trailer suspension assembly of claim 13, wherein the securing assembly includes:
a vertical interior support member attached to a portion of the associated trailer frame;
a vertical exterior support member attached to a portion of the associated trailer frame and spaced from the vertical interior support member;
a pivot shaft connected to, and extending between, the vertical exterior support member and the vertical interior support member;
wherein the tab is attached to an end of the pivot shaft.

15. The trailer suspension assembly of claim 14, wherein the securing assembly further includes:
a guide arm coupled to the pivot shaft; and
a counterweight configured to bias the guide arm relative to the associated trailer frame.

16. The trailer suspension assembly of claim 15, wherein the latch support assembly includes:
a stub column disposed adjacent to the vertical exterior support member and coupled to a portion of the associated trailer frame; and
a latch bracket attached to a portion of the stub column;
wherein the latch is configured for removable securement with the tab to prevent rotation of the pivot shaft within the vertical exterior support member.

17. A trailer suspension assembly for an associated trailer frame, the trailer suspension assembly comprising:
a mounting bracket;
a pivot arm rotatably connected to the mounting bracket;
a locking system configured to be selectively locked or unlocked;
wherein, when locked, the locking system is configured to prevent rotation of the mounting bracket to prevent movement of the associated trailer frame.

18. The trailer suspension assembly of claim 17, further comprising:
a transfer shaft connected to the mounting bracket and configured to be rotatably coupled to the associated trailer frame;
wherein, when locked, the locking system is configured to prevent rotation of the transfer shaft to prevent movement of the associated trailer frame.

19. The trailer suspension assembly of claim 18, further comprising a suspension subassembly including:
the mounting bracket; and
a leg connected to the mounting bracket;
wherein, when locked, the locking system is configured to prevent rotation of the leg to prevent movement of an associated trailer frame.

20. The trailer suspension assembly of claim 17, wherein the locking system further includes:
a securing assembly;
a tab connected to a portion of the securing assembly;
a latch support assembly;
a latch pivotably attached to a portion of the latch support assembly and aligned adjacent with the tab; and
a locking pin attached to a portion of the latch support assembly and configured to secure the latch to prevent movement of the latch.
